(19) United States
(12) Patent Application Publication
(10) Pub. No.: US 2005/0280190 A1
(43) Pub. Date: Dec. 22, 2005

(54) Method of manufacturing a preform for a composite material

(75) Inventor: Makoto Fujita, Anjo-shi (JP)

Correspondence Address: DARBY & DARBY P.C., P. O. BOX 5257, NEW YORK, NY, 10150-5257, US

(73) Assignee: Central Motor Wheel Co., Ltd., Aichi (JP)

(21) Appl. No.: 11/093,438

(22) Filed: Mar. 29, 2005

(30) Foreign Application Priority Data
Feb. 20, 2003 (JP) JP2003-042951

(51) Int. Cl. C04B 33/32

(52) U.S. Cl. 264/640

(57) ABSTRACT

Premixed material was formed by mixing alumina fiber and/or carbon fiber, titanium oxide particle and aluminum powder and was sintered to bind alumina (aluminum oxide), produced by the oxidation-reduction reaction of titanium oxide particles and aluminum powder, and a titanium-nitrogen compound in a film on the surface of alumina fiber and/or carbon fiber, and to form preform for the composite material. The composite material had high strength because preform for the composite material produced by the manufacturing method had excellent strength and breathability, and occurrence of unfilled pore space in the composite material formed by impregnating hot solution of such as aluminum alloy was prevented.

### BACKGROUND OF THE INVENTION

(1) Field of the Invention

The present invention relates to a method of manufacturing a preform for a composite material which can form a composite material by impregnating a hot solution of a light metal.

(2) Description of the Background Art

A use of a part made of a light metal such as aluminum which is excellent for lowering weight, providing high durability and low thermal expansion coefficient property, for example, in an automobile to increase its fuel efficiency, stable running and safety is increasing as trend. Some of parts used in an automobile are a part for an engine used under severe condition and such part is made of a composite material in which a light metal is compounded with a reinforcement material such as a ceramics to perform farther lowering weight and increasing durability. A composite material which was formed by impregnating a hot solution of a light metal to a preform for a composite material after forming the preform for the composite material with reinforcement materials in advance was well known. According to such forming method, for example, when a specific part was needed to be reinforced, the structural parts could be integrally formed by pouring the hot solution into the metal mold with a certain shape after arranging the preform for the composite material to form a specific part.

In general, after mixing reinforcement material such as a short fiber, a whisker, a ceramics particle and a metal particle in water and suctioning water by a filter, the preform for the composite material was produced by sintering the mixture at certain temperature. In many cases, an inorganic binder was mixed so that each reinforcement material was easily sintered and bound by gelating and crystallizing the inorganic binder. Referring to FIG. 9, preform x for composite material manufactured by such way has low breathability because ceramics particle w and metal particle s were dispersedly binding around short fiber r and whisker t, and filling almost lattice-like pore spaces formed by folding of short fiber r and whisker t. When a hot solution of a light metal such as aluminum alloy was impregnated to the preform of the composite material, it was difficult that the hot solution enters into pore spaces in the preform of the composite material so that pore spaces were remained unfilled with the light metal and the composite material could not have sufficient strength. Further a pressure during impregnating a hot solution of a light metal had been increased to prevent forming unfilled pore space, but the effect was limited and its production cost had been increased.

The manufacturing method of the preform of the composite material was disclosed in Japanese Laid Open Patent Publication H11-226718, in which a ceramics particle and a metal oxide reacted and bound each reinforcement material by sintering at approximately 1100° C. after mixing a ceramics fiber such as an aluminum short fiber and a ceramics particle such as titanium oxide and silica particle, and a metal oxide such as aluminum oxide. The preform of the composite material produced by such method was relatively more breathable in comparison with the above case because clump-like ceramics was bound on the surface of the alumina short fiber by reacting the ceramics particle and the metal oxide. Accordingly impregnation of the hot solution of a light metal such as aluminum alloy could be carried out at relatively low pressure and occurrence of unfilled pore space could be reduced.

In the manufacturing method above in which the ceramics particle and the metal oxide were mixed and sintered, even though a reaction of the ceramics particle and the metal oxide was accelerated at approximately 1100° C. for sintering, the reaction did not proceed well and the clump-like ceramics was bound on the surface of the alumina short fiber. Further an inorganic binder was mixed in processing to produce the preform of the composite material to bind the clump-like ceramics and the alumina short fiber because in the above reaction the clump-like ceramics and the alumina short fiber were not able to be bound sufficiently. In such preform for the composite material, pore spaces based on the alumina short fiber were not sufficiently secured and improvement of breathability was not satisfactory because the clump-like ceramics was projected from the surface of alumina short fiber. Accordingly when the hot solution of aluminum alloy was impregnated to the preform of the composite material, unfilled pore spaces were easily formed and the strength which the composite material could obtain was limited. Especially when the preform for the composite material was highly densified to increase strength of the composite material, high impregnating pressure was needed because pore spaces were extremely decreased and many unfilled pore spaces were easily formed.

On the other hand, own strength of the preform for the composite material produced by sintering with an inorganic binder was limited because binding force of the inorganic binder was relatively low. Therefore when impregnating rate of the hot solution was increased, the preform of the composite material was deformed or broken due to an impact of impregnation of the hot solution, and accordingly it was difficult to increase productivity by increasing impregnating rate of the hot solution.

### BRIEF DESCRIPTION OF THE DRAWINGS

FIGS. 1A-1C are figures illustrating a manufacturing process of preform I for composite material.

FIGS. 2A-2D are expanded photographs sowing alumina short fiber 2, aluminum powder 3, titanium oxide particle 4 and aluminum borate whisker 5.

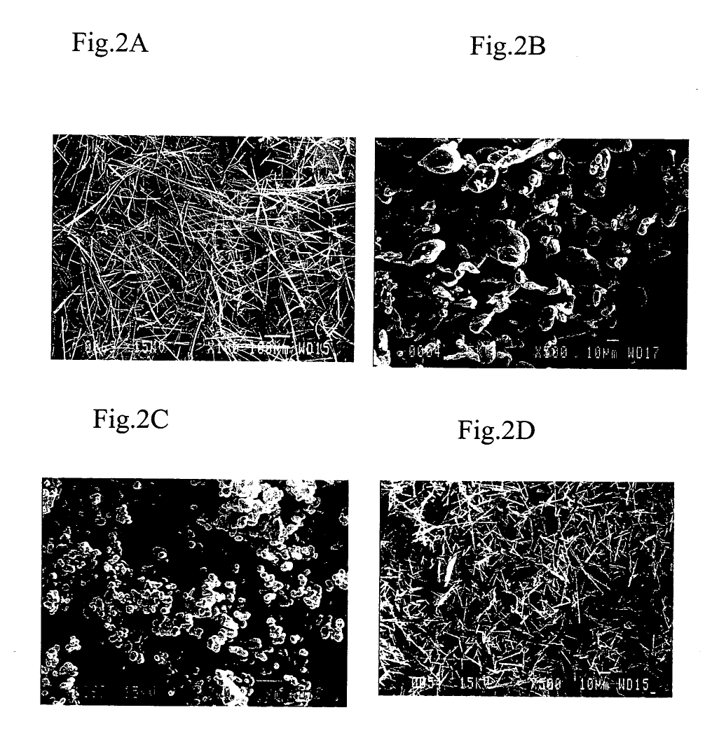

FIG. 3 is a figure illustrating preform 1 for composite according to an embodiment of the invention.

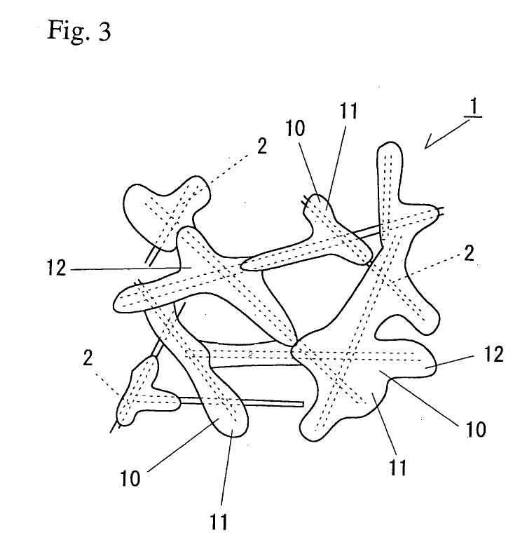

FIGS. 4A-4B are expanded photographs showing preform I for composite material according to an embodiment of the invention.

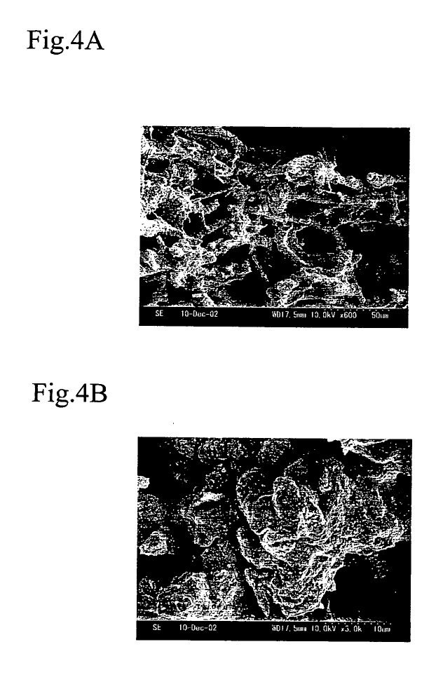

FIGS. 5A-5D are figures illustrating a casting process according to an embodiment of the invention.

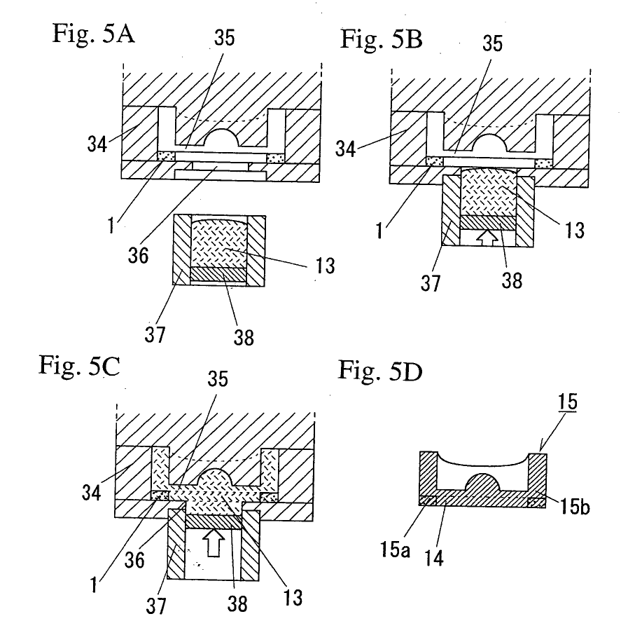

FIG. 6A is an expanded photograph showing composite region 15a of aluminum composite material 15 according to an embodiment of the invention.

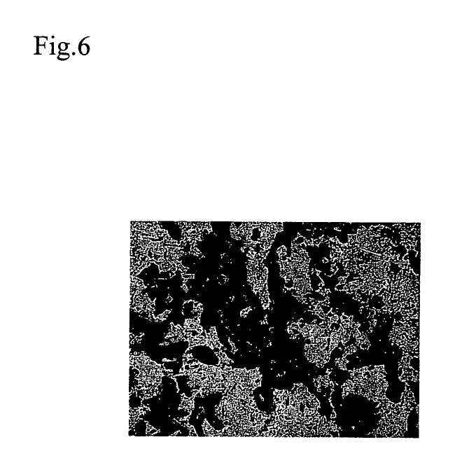

FIGS. 7A-7B are expanded photographs showing preform 40 for composite material according to a comparison embodiment of the invention.

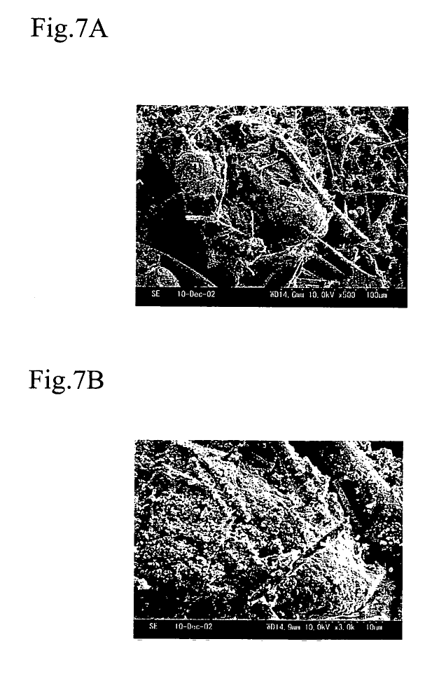

FIG. 8 is an expanded photograph showing a composite region of aluminum composite material 15 according to a comparison embodiment of the invention.

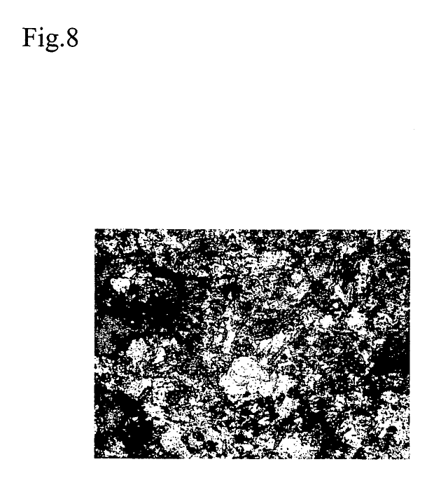

FIG. 9 is a figure illustrating preform x for composite material manufactured using a traditional manufacturing method.

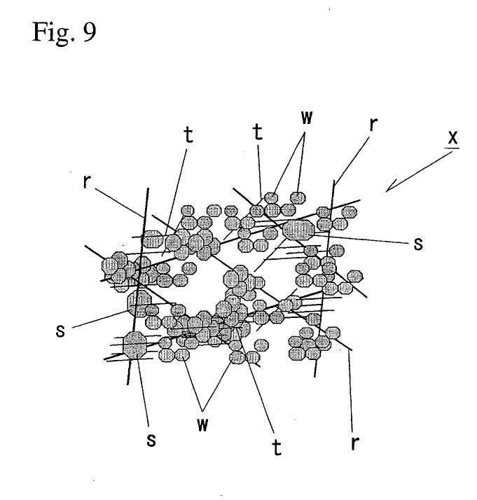

### SUMAMRY OF THE INVENTION

According to the invention, a method of manufacturing a preform for composite material, which can resolve the above issues and increase productivity of a composite material, and by which the composite material with the preform for the composite material can perform excellent strength, is disclosed.

According to an implementation of the invention, a manufacturing method of a preform for a composite material comprises steps of mixing an alumina fiber and/or a carbon fiber and titanium oxide particle which is used as a ceramics particle, adding aluminum powder to form almost homogeneous pre-mixture which is sintered at certain temperature, and binding alumina (aluminum oxide), which is produced by oxidation-reduction reaction from titanium particles and aluminum powder, and a titanium-nitrogen compound in a film on the alumina fiber and/or the carbon fiber.

In the above manufacturing method, it is utilized that an oxidation-reduction reaction of titanium oxide (TiO₂) and aluminum powder (Al) takes place at relatively low temperature, and alumina (Al₂O₃) produced by the reaction and titanium-nitrogen (Ti—N) which is formed by reaction of titanium (Ti) dissolved by the reaction and Nitrogen in the air are bound like film on the surface of alumina fiber and/or carbon fiber with reaction heat generated by the oxidation-reduction reaction. The following are formulae of the oxidation-reduction reaction.
3TiO₂+4Al→3Ti+2Al₂O₃+ΔH (1)
Ti+N→Ti−N (2)

As illustrated in formula (1), if certain heat is added, titanium oxide (TiO₂) and aluminum powder (Al) react to produce titanium dissolved from titanium oxide by reduction and alumina (aluminum oxide; Al₂O₃) formed by oxidation from the aluminum powder and generate relatively large reaction heat (ΔH). With the heat, the reaction is accelerated farther, and also according to formula (2), titanium (Ti) reacts with nitrogen (N₂) in the air to produce titanium-nitrogen compound. Titanium-nitrogen compound is produced as melted condition on the surface of alumina fiber or carbon fiber. And then alumina (Al₂O₃) and titanium-nitrogen compound (Ti—N) are bound like film on the surface with reaction heat generated by oxidation-reduction reaction. The surface condition of alumina (Al₂O₃) and titanium-nitrogen compound (Ti—N) formed like film on the surface of fiber is relatively smooth. Further, adjacent fibers can be also bound by alumina (Al₂O₃) and titanium-nitrogen compound (Ti—N).

The preform for the composite material produced by sintering pre-mixture can sufficiently secure pore spaces formed by the fibers and have excellent breathability because alumina (Al₂O₃) and titanium-nitrogen compound (Ti—N) are filmed on the alumina fiber and/or the carbon fiber with smooth surface condition. Accordingly a hot solution of such as aluminum alloy can easily impregnate and occurrence of unfilled pore space in composite material can be prevented. Further when impregnating pressure of the hot solution is relatively low or the preform for the composite material is highly densified, the hot solution can be adequately impregnated. Accordingly a composite material formed from the preform of the composite material can provide high strength and can be optimally used for a part such as above automobile engine part which requires high durability.

In the above manufacturing method, a stronger binding force than a traditional method can be obtained because alumina fiber or carbon fiber and alumina and titanium-nitrogen compound are sintered by the oxidation-reduction reaction. Therefore the preform for the composite material might have high strength and would not be deformed or broken even if the hot solution of aluminum alloy is impregnated at relatively high temperature; and accordingly the composite material which has the excellent strength could be formed.

The oxidation-reduction reaction of titanium oxide and aluminum powder proceeds at relatively low temperature and generates large reaction heat. Sintering temperature can be lowed in comparison with a traditional method because the reaction heat which farther accelerates the reaction. Reduction of production processing cost of the preform for the composite material can be achieved. Further it is excellently advantageous that preheat of the preform for the composite material for impregnating sufficiently the hot solution and temperature of the hot solution in impregnating process of the hot solution of such as aluminum alloy can be set lower than before and accordingly farther reduction of production cost can be achieved.

According to an implementation of the invention, a manufacturing method of a preform for a composite material comprises steps of forming pre-mixture by almost homogeneously mixing ceramics whisker and binding alumina (aluminum oxide) like film and titanium-nitrogen compound on the surface of the ceramics whisker is disclosed. In the manufacturing method, own strength of the preform for the composite material is increased by mixing and sintering ceramics whisker to densify the preform for the composite material. As well as alumina fiber or carbon fiber, when the ceramics whisker is sintered, ceramics whisker is filmed with alumina and titanium-nitrogen compound formed by oxidation-reduction reaction and strongly bound and also is bound to adjacent fiber or whisker. Therefore even if densifying is carried out according to the manufacturing method, pore spaces in the preform for the composite material are secured and the preform for the composite material which has excellent breathability can be produced.

According to an implementation of the invention, a manufacturing method in which aluminum borate whisker is used as a ceramics whisker is disclosed. In such manufacturing method, an aluminum borate whisker acts to densification as above and reacts with titanium dissolved by oxidation-reduction reaction referring to reaction formula (1). Specifically, titanium (Ti) dissolved in the oxidation-reduction reaction and boron of aluminum borate whisker (9Al₂O₃.2B₂O₃) react to form titanium-boron compound (Ti—B) by using reaction heat (ΔH) generated by the oxidation-reduction reaction according to the above formula (1). And then titanium-boron compound is bound like film on the surface of the fiber together with the above alumina (aluminum oxide) and the titanium-nitrogen compound by reaction heat generated at the same time. The composite material which is produced by filling the aluminum alloy into the preform for the composite material can be used in a part of an automobile engine which requires sliding property at high temperature and durability because the titanium-boron compound comprises excellent abrasion resistant property and low thermal expansion coefficient property.

According to an implementation of the invention, in the manufacturing method using the above titanium oxide of which particle diameter is in the range of 0.1 μm to 10 μm is disclosed. The above oxidation-reduction reaction proceeds when titanium oxide contacts to the aluminum powder melting at high temperature and therefore if titanium oxide is smaller particle than 10 μm of particle diameter, relatively many particles can contact to aluminum powder and the reaction easily proceeds. Titanium oxide of which particle diameter is in the range of 0.1 μm to 10 μm are used because if the particle diameter of titanium oxide is smaller than 0.1 μm, handling property is not good and it is difficult to obtain it in market. Further, relatively easily obtainable small particle having particle diameter which is in the range of 0.2 μm to 1 μm are generally optimally used. Even if the particle diameter is slightly out of range, it is covered by the invention because production of targeted the preform of the composite material can be carried out.

According to an implementation of the invention, a manufacturing method using the above aluminum powder of particle diameter is smaller than 200 μm is disclosed. The above pre-mixture to form the preform for the composite material is formed generally by drying after stirring each reinforcement material in water. In such processing, if aluminum powder of which particle diameter is larger than 200 μm is used, it is difficult to be dispersed in water even by stirring and easily sinks during drying and accordingly aluminum powder is irregularly arranged in the pre-mixture obtained after drying. When such pre-mixture is sintered, portions having good or bad breathability are formed because the above oxidation-reduction reaction does not take place in all area of the preform for the composite material. Therefore aluminum powder of which particle diameter is smaller than 200 μm is used to form the pre-mixture in which aluminum powder are almost homogeneously mixed. On the other hand, aluminum powder of which particle diameter is smaller than 10 μm is difficult to be handled and aluminum powder of which particle diameter is larger than 10 μm is optimal to secure sufficiently the contact amount above with titanium oxide. Further more preferably particle diameter is in the range of 30 μm to 80 μm wherein it can be easily equally dispersed in the pre-mixture and is relatively easily handled.

Even if the particle diameter of aluminum powder is slightly out of range, it is covered by the invention because production of targeted the preform of the composite material can be carried out.

According to an implementation of the invention, a manufacturing method using an alumina fiber and/or carbon fiber which is a short fiber having an average diameter in the range of 1 μm to 50 μm and an average length in the range of 0.1 mm to 5 mm is disclosed. The average diameter or length is an average value of fiber's diameter or length of each fiber and has irregularity in near average value so that fiber's diameter or length out of such average can be included in some case. Such reinforcement fiber as well as aluminum powder has smaller average diameter than 50 μm and shorter average length than 5 mm to form almost homogeneously dispersed condition in the pre-mixture. In contrast, if the average length is longer than 5 mm, the reinforcement fiber is bent and easily forms a complex web and accordingly the preform for the composite material cannot have sufficient strength because the reinforcement fiber builds a structure of the preform for the composite material. Further if the average diameter is narrower than 1 μm or the average length is shorter than 0.1 mm, a preform for a composite material having sufficient strength cannot be formed because a binding region of the reinforcement fiber and, alumina (aluminum oxide) and titanium-nitrogen compound formed by the oxidation-reduction reaction becomes small. Further if the average diameter and/or the average length are larger than the range, the strength of the preform for the composite material can be lowered because a volume of the preform for the composite material after sintering becomes large. Accordingly, by using alumina fiber and/or carbon fiber which have an average diameter and an average length in the range above, a preform for a composite material having excellent strength and breathability can be adequately produced.

### DETAILED DESCRIPTION OF THE INVENTION

The inventor describes embodiments of the invention referring to figures.

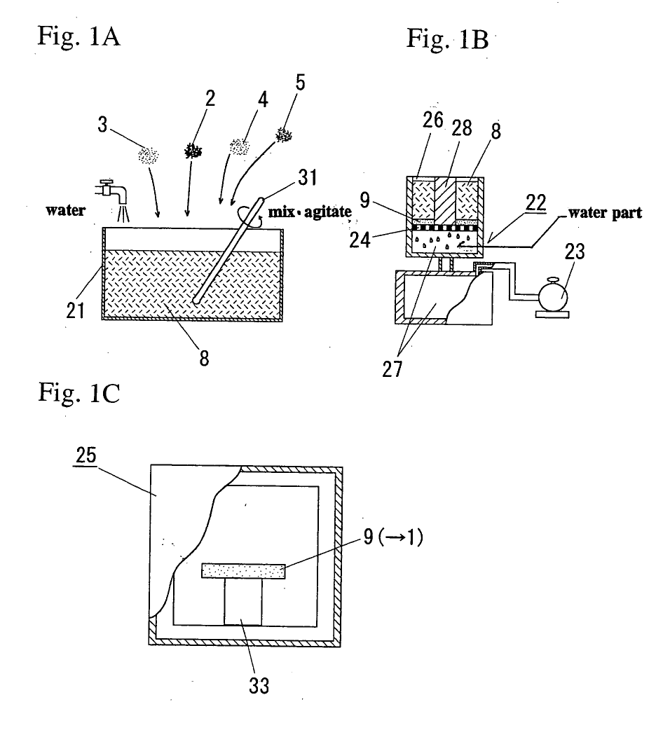

FIG. 1 is a figure illustrating a process of manufacturing a preform for a composite material. FIG. 1(a) is a mixing process which prepared aqueous mixture 8 by almost

1. A manufacturing method of a preform for composite material comprising the steps of:
mixing alumina fibers and/or carbon fibers and titanium oxide particles;
adding an aluminum powder to form a substantially homogeneous pre-mixture; and
sintering said pre-mixture at a predetermined temperature,
wherein alumina (aluminum oxide), produced by an oxidation-reduction reaction of the titanium particles and the aluminum powder, and a titanium-nitrogen compound in a film on a surface of the alumina fiber and/or the carbon fiber.

2. A manufacturing method of a preform for composite material according to claim 1 further comprising the steps of:
forming a ceramics whisker by almost homogenously mixing the pre-mixture; and
binding the alumina (aluminum oxide) like film and the titanium-nitrogen compound on a surface of said ceramics whisker by sintering said pre-mixture.

3. A manufacturing method of preform for composite material according to claim 2;
wherein ceramics whisker is aluminum borate whisker.

4. A manufacturing method of preform for composite material according to claim 1;
wherein the titanium oxide particle comprising particle diameter which is in the range of 0.1 μm to 10 μm.

5. A manufacturing method of preform for composite material according to claim 1;
wherein the aluminum powder comprising particle diameter which is equal or smaller than 200 μm.

6. A manufacturing method of preform for composite material according to claim 1;
wherein the alumina fiber and the carbon fiber comprising a short fiber having an average diameter which is in the range of 1 μm to 50 μm, and an average length which is in the range of 0.1 mm to 5 mm.
